(19) United States
(12) Patent Application Publication
(10) Pub. No.: US 2025/0292655 A1
(43) Pub. Date: Sep. 18, 2025

(54) MUST-WIN BY SYMBOL DRIVEN PROGRESSIVES

(71) Applicant: IGT, Las Vegas, NV (US)

(72) Inventors: Kevin HIGGINS, Reno, NV (US); Jeffery SHEPHERD, Reno, NV (US)

(21) Appl. No.: 19/224,637

(22) Filed: May 30, 2025

Related U.S. Application Data
(63) Continuation of application No. 17/875,048, filed on Jul. 27, 2022.

(51) Int. Cl. G07F 17/32; G07F 17/34

(52) U.S. Cl. CPC G07F 17/3258; G07F 17/3223; G07F 17/34

(57) ABSTRACT

Provided is a gaming system includes a progressive award. Typically, a progressive award includes an initial amount and an additional amount funded through a portion of each wager placed to initiate a play of a primary game. When one or more triggering events occurs, the gaming system provides at least a portion of the progressive award. After the gaming system provides the progressive award, an amount of the progressive award is reset to the initial amount and a portion of each subsequent wager is allocated to the next progressive award.

### CROSS REFERENCE TO RELATED APPLICATIONS

The present application is a continuation of U.S. patent application Ser. No. 17/875,048, filed Jul. 27, 2022, entitled, “MUST-WIN-BY SYMBOL DRIVEN PROGRESSIVES,” the disclosure and content of which is incorporated herein in its entirety.

### BACKGROUND

Mystery progressive wagers may provide that the system selects one game to win the prize at a certain time or a certain prize level. For example, the system may typically have a random number generator (RNG), which is used to determine the jackpot level the mystery progressive must reach to select a winning player. The mystery system may also be configured to select the random number within a range, where the top end of the range is the “must hit by” value. For example, the mystery progressive system can be configured to award a “must hit by” progressive randomly in the range between $10 k and $20 k, and the RNG will determine that the current “must hit by” level value is $17200.

There is a need for different types of games to attract a wider variety of players of different wagering games.

### BRIEF SUMMARY

According to some embodiments, a system includes a processor circuit and a memory including machine-readable instructions. When executed by the processor circuit, the instructions cause the processor circuit to operations disclosed herein. Operations according to some embodiments include receiving an indication of a wager for a symbol-based wagering game by a player at a gaming device. In some embodiments, the symbol-based wagering game includes a gaming device wagering game that includes a gaming device prize that corresponds to the gaming device and a mystery progressive wagering game that includes a mystery progressive prize that includes an initial amount and an additional amount that is funded through a portion of a second machine wager that is received by a second gaming device. Some embodiments provide that the second gaming device is different from the first gaming device.

Some embodiments include determining, using a random number generator, a must-hit-by characteristic of the mystery progressive prize. Embodiments may further include generating multiple symbol combinations that are defined in a paytable that includes gaming device prize data. Some embodiments provide that the must-hit-by characteristic is based on a value of the mystery progressive prize.

Some embodiments herein are directed to methods that perform operations discussed herein. Operations include receiving a wager for a symbol-based wagering game at a gaming device. Some embodiments include determining a must-hit-by value corresponding to a mystery progressive wagering game that is provided on the gaming device. Operations include sending, to multiple gaming devices, the must-hit-by value corresponding to the mystery progressive wagering game and determining, based on a difference between a mystery progressive award value and the must-hit-by value, an adjusted probability of ones of multiple symbol combinations triggering an award of the mystery progressive wagering game.

According to some embodiments, a gaming device includes a display device, an input device, a processor circuit, and a memory including machine-readable instructions. When executed by the processor circuit, the instructions cause the processor circuit to receive a wager for a symbol-based wagering game at a gaming device, determine a must-hit-by value corresponding to a mystery progressive wagering game that is provided on the gaming device, send, to multiple gaming devices that includes the gaming device, the must-hit-by value corresponding to the mystery progressive wagering game, and determine, based on a difference between a mystery progressive award value and the must-hit-by value, an adjusted probability of ones of multiple symbol combinations triggering an award of the mystery progressive wagering game. Operations further are configured to receive, from the gaming device, an indication that the mystery progressive prize is being awarded, determine an updated must-hit-by value, and cause the updated must-hit-by value to be sent to other ones of the gaming machines. In some embodiments, a portion of the symbol combinations in a paytable that trigger the mystery progressive prize and a difference between the must-hit-by value and the mystery progressive award value comprise a negative correlation.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIG. 3 is a schematic bar graph illustrating mystery controller segments and weightings of each segment according to some embodiments disclosed herein.

FIG. 4 is a schematic block diagram illustrating operations of a distributed mystery controller and hit coordination across a mystery controller in a network according to some embodiments herein.

FIG. 5 is a schematic block diagram illustrating operations of a distributed mystery controller and hit coordination across the controller in a network according to some embodiments herein.

FIG. 6 is a schematic block diagram illustrating operations of a distributed mystery controller and hit coordination across the controller in a network according to some embodiments herein.

FIG. 7 is a flowchart illustrating operations of systems/methods of facilitating participation in a wagering game between multiple devices, according to some embodiments.

FIG. 8 is a flowchart illustrating operations of systems/methods of facilitating participation in a wagering game between multiple devices, according to some embodiments.

### DETAILED DESCRIPTION

Symbol driven progressives are prizes where multiple slot machines are linked by the system and prize accumulation is controlled by the system, but winning the prize is determined by the slot machine. Inside each slot machine there is a paytable. The paytable controls which combination of random number or wheel stops pay off and which combination determines a progressive prize win. The benefit of having the paytable determine the win is that the game presentation can easily customize itself in a way to make the player aware of the progressive win and therefore make the player experience much more entertaining. For example, the base game may hit 5 Wheel of Fortune symbols on a payline.

In some embodiments, mystery progressives may provide that the system determines the win, which allows the progressive to be spread across more game themes than is possible with a symbol driven progressive. However, one disadvantage may be that there is no integration with the game's presentation. As such, the excitement that players feel may be much less. For example, players may only see a simple text notification on a vacuum florescent display (VFD), or see a celebration in the Service Window or secondary screen attached to the EGM. The other downside of mystery progressives is that the system is determining the win, which may require the system to be regulated as a gaming device. Some embodiments provide that such requirement may hamper the ability to build a system that leverages modern readily available technologies.

As provided herein, some embodiments may provide game determined must-hit-by symbol driven progressives, which may be more exciting than mystery progressives that may be less appealing from a player excitement and fun perspective. Thus, various mechanisms herein provide a “must hit by” progressive where the EGM determines the winner rather than a component of the system.

Some embodiments herein include multiple options to address this issue and to support “must hit by” progressives where the EGM triggers the award. In some embodiments, “must hit by” progressives may be incorporated into a system that may help eliminate any requirement for components of such system to be regulated as a gaming device.

In a paytable triggered mystery hit, the EGM may associate varying paytable win levels that are eligible to win the mystery prize based upon the current value of the mystery progressive. As the centrally controlled prize gets closer to the must-hit-by prize, then the number of win levels (and types of win levels) that will hit the mystery progressive prize goes up. Theoretically, when the must-hit-by prize is reached all combinations in the paytable may award the prize.

To ensure the fairness of the game, the paytable may not change based upon the current level of the associated mystery progressive and if the combination that triggers the prize hit is also a normal game win, then that paytable prize may be paid in addition to the progressive award.

The presentation of the EGM when the player won the must-hit-by prize can be done in a few ways. If the combination hit that awards the mystery progressive prize is not typically associated with winning the mystery progressive, then a dynamic presentation may be added. For example, the EGM (e.g., slot machine) can alter the presentation of that combination and display a winning combination associated with winning the mystery progressive.

In some embodiments, the EGM can present the presentation of the winning base-paytable combination, but use an alternate display and/or overlaid display to present that the progressive prize was won. For example, the EGM may overlay on the winning symbols some additional information, or symbol information that describes winning the mystery progressive. The adjustment of the number of mystery prize winning combinations can be driven inside the EGM by remotely configuring the must hit by prize in the EGM and also by the mystery progressive system periodically sending the current prize level to the slot machines. In some embodiments, the jurisdiction where the EGM is running may require the odds of winning a mystery to match certain ratios in order to minimize the impact to player fairness as players play across the range of progressive values between the mystery progressive reset value and the “must hit by” value. For example, some jurisdictions may require odds to be managed via weighted tables with maximum table segment weightings between adjacent segments and the beginning or starting segment and ending segment. In some jurisdictions, the EGM must adjust the odds of winning according to both the current mystery progressive level and the current table segment weightings for where the mystery progressive level value currently is.

Some embodiments provide that time may also drive the award of the winning prize. As the time gets closer to the must hit by time, the number of combinations awarding the mystery progressive prize can be increased.

In some embodiments, the EGM can keep track of non-normal mystery prize-winning combinations by updating information directly in the paytable, and/or a list of non-normal prize winning combinations could be held outside the paytable and checked with each game play. After a mystery progressive hit (by the current EGM, or any EGM on the mystery progressive link), any updates to the paytable or the external list would be cleared and reset. It is contemplated that multiple prizes for a game or game/denomination combination could be supported by this scheme.

While the must-hit-by scheme does not affect the win of the base paytable or the non-progressive part of the theoretical hold of the EGM, the must-hit-by logic for symbol driven games may provide that the game hits the progressive prize before the theoretical prize hit rate. This is because the must-hit-by odds of hitting only reach 1.0 when the must-hit-by progressive prize value is reached thus guaranteeing the prize is hit. Upon prize hit, the EGMs can, along with sending the prize hit, send the list of progressive prize hit stops to a central system that were added to the list of winning values. This may allow analysis to determine that, over time, the machine is computing truly random outcomes and the progressive prize hits are a result of random outcomes.

An example of the math controlling the must-hit-by progressive is presented in Table 1 below. In this example the must hit by prize value is $16,000,000 and the odds of any one game play hitting the single outcome is 1:48,000,000,000. As the prize rises toward 16,000,000, irrespective of the contribution rate of game play to progressive prize, the odds of winning change accordingly. The winning combos below are the first winning combination defined by the paytable and other winning combinations are those randomly chosen by the game and added to the list of combinations to be checked at the end of each play cycle to determine if the player won the mystery progressive prize.

TABLE 1

| Current | | Odds of |
|---|---|---|
| Progressive Prize | Winning Combos | winning |
| <12,000,000 | 1 | 1:48,000,000 |
| 12,000,000+ | 16 (1 above + 15 randomly chose) | 1:3,000,000 |
| 13,000,000+ | 256 (+240 more random outcomes) | 1:187,500 |
| 14,000,000+ | 4096 (etc) | 1:11719 |
| 15,000,000+ | 32768 (etc) | 1:1465 |
| 16,000,000 | 48,000,000 (etc) | 1:1 |

As provided herein, Table 1 above is a non-limiting example of how the math to achieve 1:1 hit rate at the must-hit-by value can be derived. In this regard, it is appreciated that numerous EGMs playing the game, and a frenzy of players playing, and as the prize grows closer to the must-hit-by value, the likelihood of nearing the 16,000,000 must hit by value is greatly diminished and the prize becomes much more likely to be hit.

While it may be advantageous for each game to select the outcomes that hit the prize, the burden of selecting the outcomes that hit the prize may be done by a central system and the central system may communicate the list of outcomes to the games. This may achieve a level of perceived fairness since every game would be competing for the same outcomes. However, assuming that all outcomes in an EGM are equally likely this “fairness” may be merely a perceived phenomenon. However, certain jurisdictions may demand such perceived fairness. This list of additional outcomes, either determined by the EGM and/or determined centrally may be fixed and/or may change from time to time.

In another embodiment, the system may leverage the RNG to determine a winning time within the next month, such as May 17^{th} at 11:00 am. Once a mystery hit occurs (hitting the “must hit by value”, or “must hit time”, etc.), the winning EGM may be selected by the system from the list of games that are active with a player playing for the mystery prize. There are no games determined must-hit-by symbol driven progressives.

In some embodiments, the EGM may run the mystery controller. For example, the EGM itself can run a local mystery controller that is seeded with the parameters of the progressive from the system during initial setup and/or when a reset occurs. In some embodiments, that local controller can determine its own “hit level”, or “hit time”. When a player plays a game on that EGM that is configured to participate in the mystery progressive, then the EGM evaluates if the contribution from that play of the game puts the EGM over the pre-configured “hit level”, or represents a bet at, or after the “hit time” chosen by that EGM at the last reset. When the EGM determines that it has won, it then may report the win to the central system. In this architecture, the EGM's mystery controller determines the “hit level” or “lucky coin” at initialization, and/or the last reset of the controller, and/or when another controller hits. The EGM's local controller can also use weighted tables if there's a desire to weight the likelihood of when the lucky number is chosen between the reset value of the mystery progressive and the “must hit by” value. These weightings can be pre-configured on the EGM during initial setup, and/or be part of the configuration of the EGM software when developed by the manufacturer.

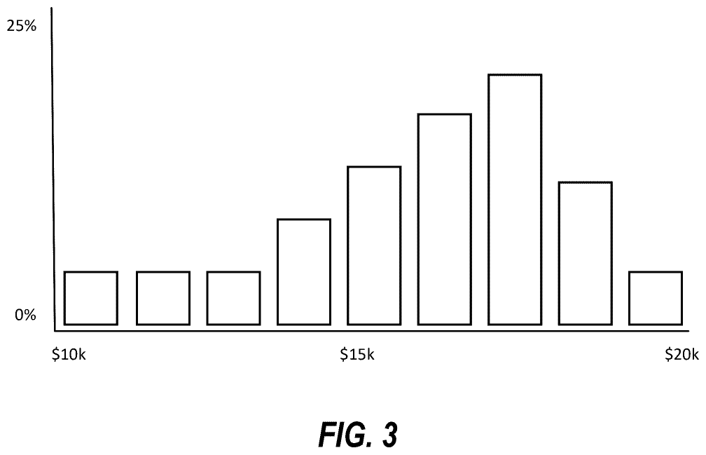

One illustration of a weighted table used to control the likelihood of when the controller's “lucky coin” number will be determined within the range of the controller reset amount and the “must hit by amount” is described in reference to FIG. 3, which is a schematic bar graph illustrating mystery controller segments and weightings of each segment according to some embodiments disclosed herein. As illustrated, different ones of the segments may have different weightings corresponding to each segment within the range of segments. For example, segments corresponding to segments from $10 k to $12 k and also the segment corresponding to $18 k all have a lower weighting than those segments corresponding to $13 k through $17 k.

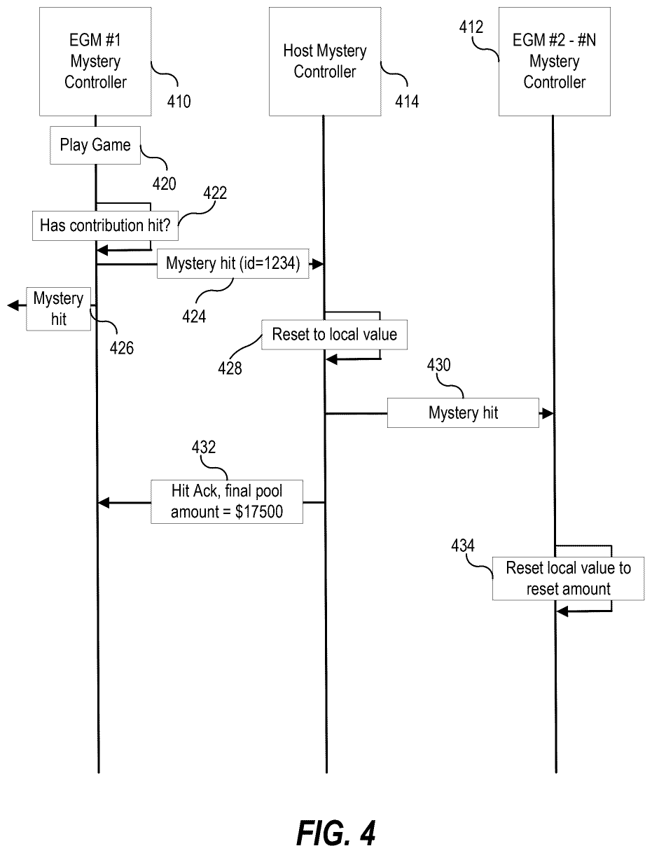

In some embodiments, each controller may be reset when another controller has a hit the award. When one EGM gets a hit, that hit results in that winning EGM notifying the other EGMs on the network that a hit has occurred. In some embodiments, the hit event or message can be sent to other EGMs on the network directly and/or indirectly via a server. For example, reference is now made to FIG. 4, which is a schematic block diagram illustrating operations of a distributed mystery controller and hit coordination across a mystery controller in a network according to some embodiments herein.

In such embodiments, a user may play a game (block 420) on a first EGM mystery controller 410. The first EGM mystery controller 410 may determine if a contribution target has been hit (block 422). If a contribution hit then the mystery hit data may be sent (block 424) to a host mystery controller 414 and the mystery hit (block 426) may be processed by the first EGN mystery controller 410.

In response to receiving the data corresponding to the hit, the host mystery controller 414 may reset (block 428) the local value of the mystery of the mystery progressive and may also send data (block 430) to other ones of the EGM mystery controllers 412 in the network. In some embodiments, the other EGM mystery controllers 412 may reset the local value of the local value (block 434). In some embodiments, the host mystery controller 414 may send (block 432) a hit acknowledgement message to the first EGM mystery controller 410.

A downside with this model is that if the quantity of EGMs is large, then the odds of the “lucky number” being lower in the range between the reset value and the “must hit by” value increase in comparison to a system just determining the “lucky number” in a single server as instead of there being one execution of the RNG to determine the “lucky number”, there are N runs (where N is the number of enrolled EGMs).

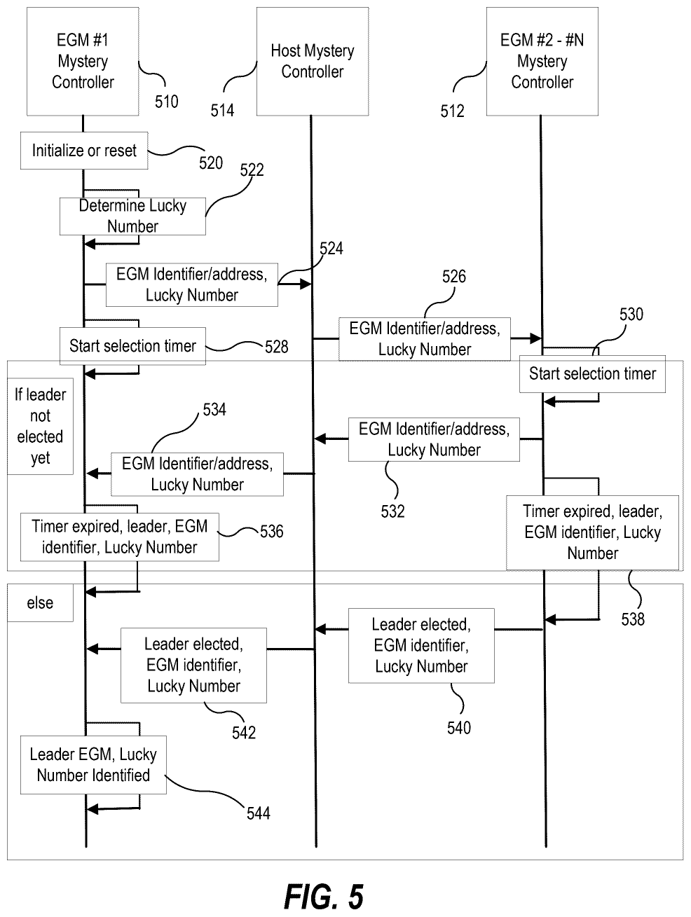

One approach to eliminate this risk is to have the EGMs communicate with each other (either directly, or indirectly via a server component) to elect the real lucky number. For example, reference is now made to FIG. 5, which is a schematic block diagram illustrating operations of a distributed mystery controller and hit coordination across the controller in a network according to some embodiments herein.

In some embodiments, upon initial configuration or reset, each connected EGM can determine its own “lucky number” given the parameters of the mystery progressive and send its “lucky number” value, along with other information that can be used by all other EGMs and/or the system to determine which “lucky number” is the elected “lucky number” for the mystery. For example, each EGM could send to other EGMs it's “lucky number”, plus it's MAC Address. After reset, EGMs could wait 1 minute, and then look through the list of lucky numbers sent by other EGMs and pick the “lucky number” received from the EGM with the lowest MAC address. At that point, each EGM can choose that as the “lucky number” for the progressive. To ensure consistency across the network, each EGM could broadcast its view of the currently elected “lucky number”, plus the MAC address of the elected number to the network of EGMs (or via an intermediary server), and this helps other EGMs confirm that it didn't miss a previous message. Other EGMs which join the progressive after the reset occurred can query the other EGMs on the network (either directly, or indirectly via a server) for their view of the currently elected “lucky timer” and the MAC address associated with that EGM. Alternatively, the new EGM can initiate an election process, and other EGMs could simply return the current “lucky number” value for the progressive. This ensures consistency on the network over the perception of the lucky number. In some embodiments, if the winning lucky number is found by any node to be inconsistent, then an EGM could call for an election for a new “lucky number” by publishing its own randomly chosen “lucky number”.

In some embodiments, the first EGM mystery controller 510 may initialize and/or reset the progressive mystery award (block 520) and determine a lucky number (block 522) that may be within a range defined by the reset value and the must hit value. The first EGM mystery controller may send (block 524) an EGM identifier, a lucky number and/or address to the host mystery controller 514. The host mystery controller 514 may send (block 526) the EGM identifier, the lucky number and/or address to other ones of the EGM mystery controllers 512. Some embodiments provide that selection timers are started 528, 530 in each of the EGM mystery controllers 510, 512 in the network.

EGM identifiers, the lucky number and/or addresses may be sent 532, 534 from the other EGM mystery controllers 512 to the host mystery controller 514 and from the mystery host controller 514 to the first mystery controller 510. In some embodiments, the EGM mystery controllers 510, 512 may determine (blocks 536, 538) if a leader of the EGM mystery controllers 510, 512 have expired timers and whether a leader EGM has been elected.

One of the EGM mystery controllers 412 may be elected leader and the leader elected EGM identifier and lucky number may be transmitted from one of the EGM mystery controllers 512 to the host mystery controller 514 and then to the first EGM mystery controller 510 after which the first EGM 510 may have the leader identified (block 544).

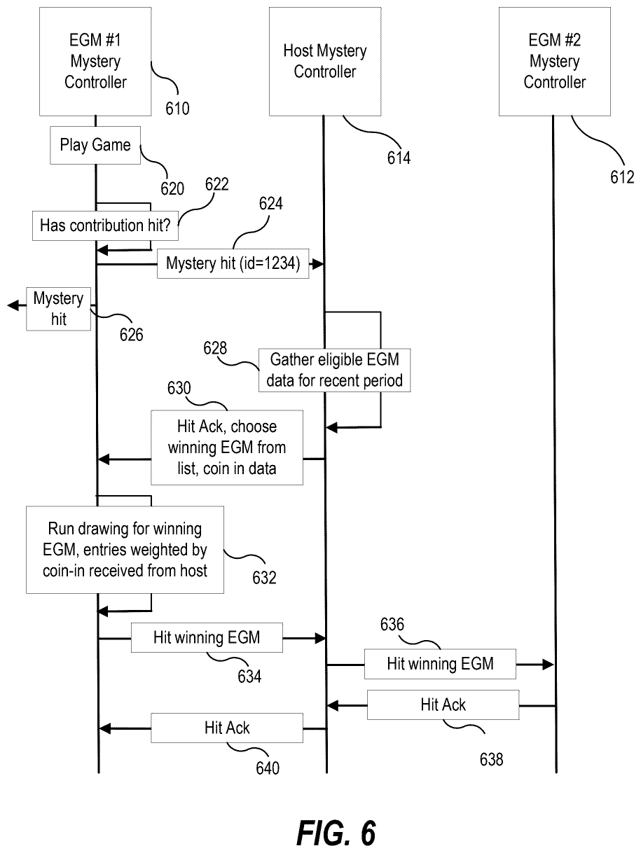

Reference is now made to FIG. 6, which is a schematic block diagram illustrating operations of a distributed mystery controller and hit coordination across the controller in a network according to some embodiments herein.

In some embodiments, the server could be monitoring or coordinating this messaging. Furthermore, the server could track the currently elected “lucky number” and perform some validation when an EGM has “hit”, or claims it won the winning lucky number. For example, the server could only react to a “hit” message if the “lucky number” and MAC address match what the server expected.

In some embodiments, the EGM to first hit the elected “lucky number” may win the mystery progressive prize. Although, since every EGM is synchronized to the mystery progressive pool value, the progressive controller could alternatively determine when a hit has occurred and select a winning EGM. In some embodiments, the server would still not contain a random number generator used to determine the “lucky number”, although an RNG could be leveraged to determine the winning EGM amongst the eligible EGMs. Other non-RNG based embodiments are possible, such as selecting the eligible EGM based upon the lowest MAC address of the eligible EGMs when a hit occurs. In other embodiments, the server could collect coin-in information from the eligible EGMs and forward that to one EGM in the network of EGMs and have that EGM's RNG determine the winning EGM. Such embodiments may ensure that the mystery controller server is RNG-free.

In a network of EGM mystery controllers, a first EGM mystery controller 610 may have game play execute thereon (block 620). The first EGM mystery controller 610 determines if a contribution hit has occurred (block 622). If so, then the first EGM mystery controller 610 sends (block 624) mystery hit data to the host mystery controller 614. The host mystery controller may gather (block 628) eligible EGM data for the recent time period.

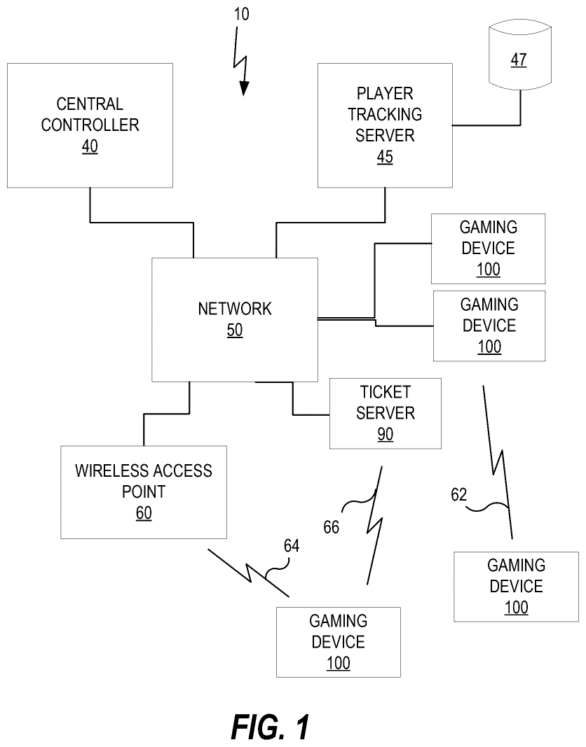

Referring now to FIG. 1, a gaming system 10 including a plurality of gaming devices 100 is illustrated. As discussed above, the gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

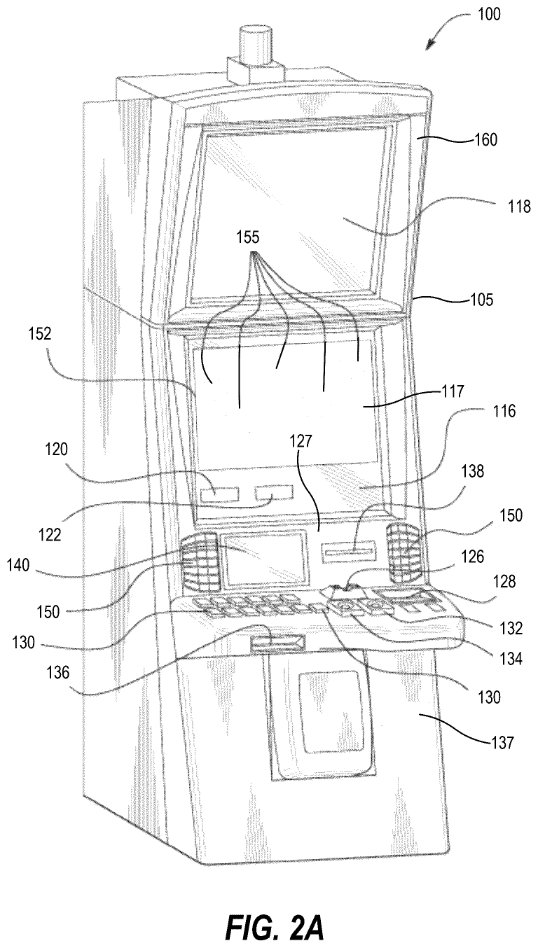

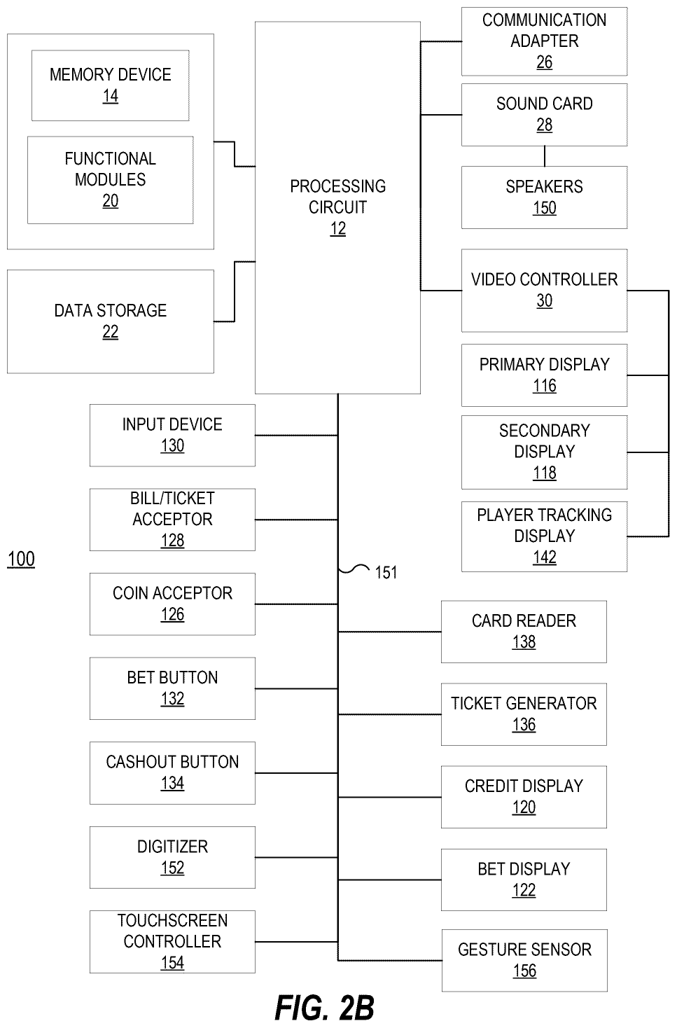

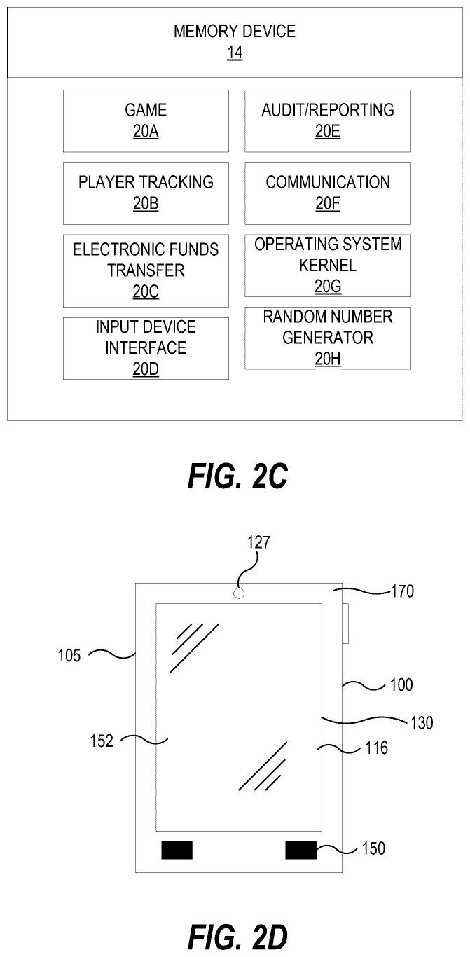

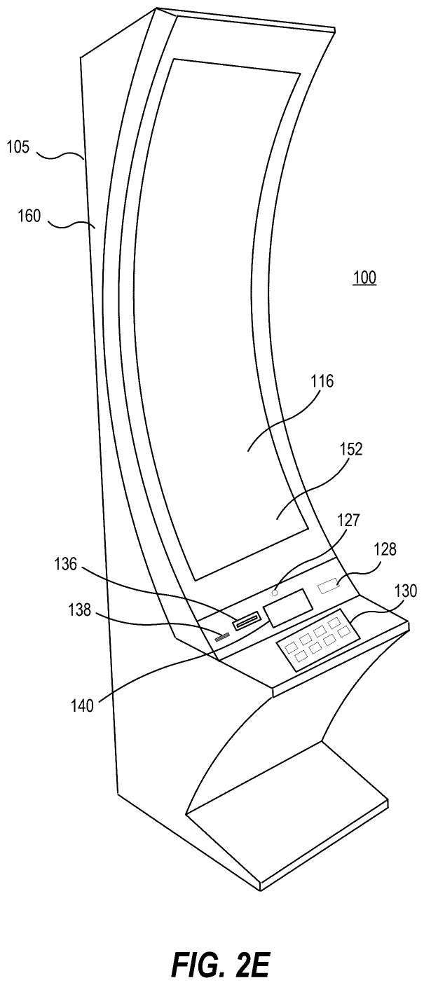

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously-placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touch-screen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

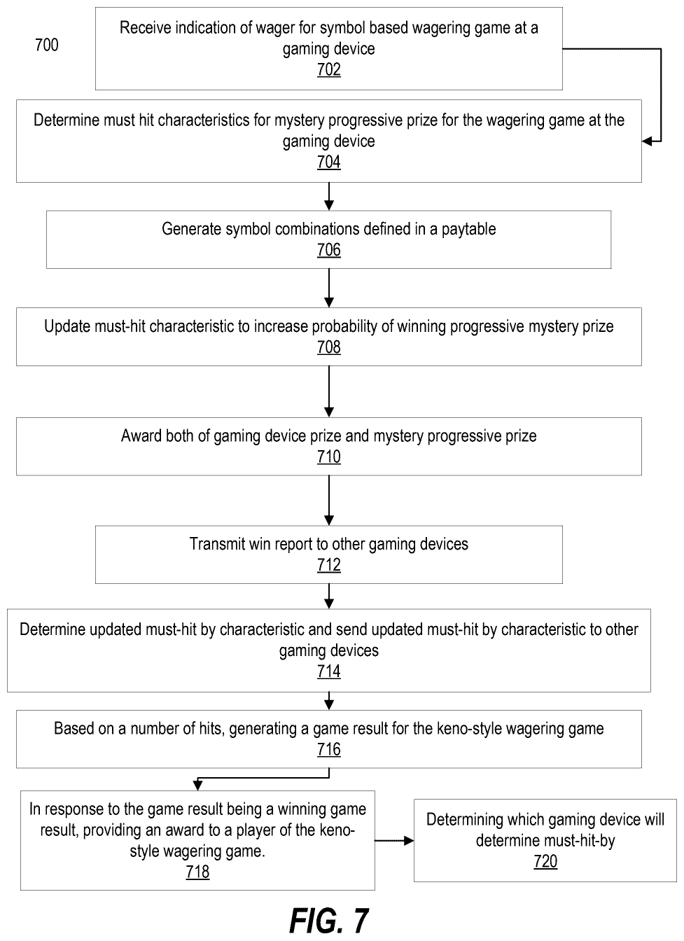

Reference is now made to FIG. 7, which is a flowchart illustrating operations 700 of systems/methods for facilitating embodiments described herein. Operations according to some embodiments include receiving (block 702) an indication of a wager for a symbol-based wagering game by a player at a gaming device. In some embodiments, the symbol-based wagering game includes a gaming device wagering game that includes a gaming device prize that corresponds to the gaming device and a mystery progressive wagering game that includes a mystery progressive prize that includes an initial amount and an additional amount that is funded through a portion of a second machine wager that is received by a second gaming device. Some embodiments provide that the second gaming device is different from the first gaming device.

Some embodiments include determining (block 704), using a random number generator, a must-hit-by characteristic of the mystery progressive prize. Embodiments may further include generating (block 706) multiple symbol combinations that are defined in a paytable that includes gaming device prize data. Some embodiments provide that the must-hit-by characteristic is based on a value of the mystery progressive prize.

In some embodiments, based on the value of the mystery progressive prize and the must-hit-by characteristic, operations include updating (block 708) the must-hit-by characteristic to increase a probability of winning the mystery progressive award. In some embodiments, the must-hit-by characteristic includes an upper limit of the value of the mystery progressive prize. In some embodiments, as the value of the mystery progressive award increases toward the upper limit, additional ones of the plurality of symbol combinations that cause the mystery progressive prize to be awarded are determined. Some embodiments provide that, responsive to the value of the mystery progressive prize reaching the upper limit, the probability of winning the mystery progressive prize is 1:1.

In some embodiments, the must-hit-by characteristic includes an upper limit on an amount of time since a previous one of the mystery progressive wagering games awarded the mystery progressive prize. Some embodiments provide that as the amount of time since the previous one of the mystery progressive wagering games awarded the mystery progressive prize increases, an amount of the plurality of symbol combinations that cause the mystery progressive prize to be awarded increases.

Some embodiments include awarding (block 710) both of the gaming device prize and the mystery progressive prize responsive to the wagering device generating a winning symbol combination corresponding to an award on the gaming device wagering game and the mystery progressive prize.

In some embodiments, responsive to the wagering device generating winning symbol combination corresponding to an award of the mystery progressive prize, operations further include transmitting (block 712) a win report to other gaming devices that include the mystery progressive wagering game. Some embodiments include sending (block 714) a reset signal to the other gaming devices that include the mystery progressive wagering game to cause the mystery progressive prize to be reset to the initial amount. Some embodiments include determining (block 716) an updated must-hit-by characteristic and sending (block 718) the updated must-hit-by characteristic to the other gaming devices that include the mystery progressive wagering game.

In some embodiments, the processor circuit includes a local EGM mystery controller to determine a must-hit-by characteristic that includes data corresponding to triggering the award of the mystery progressive prize.

Some embodiments operations include determining (block 720) which one of multiple gaming devices that include the mystery progressive wagering game will determine the must-hit-by characteristic.

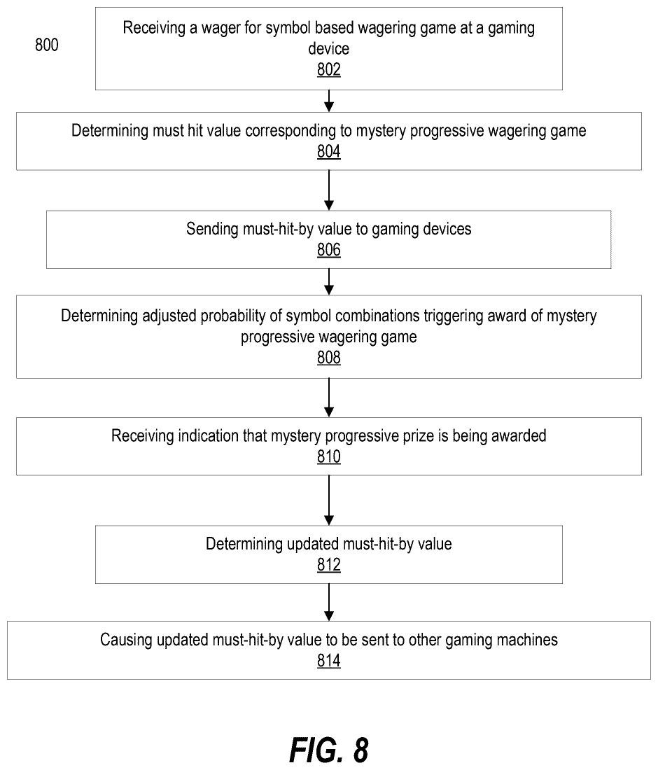

Reference is now made to FIG. 8, which is a flowchart illustrating operations 800 of systems/methods for facilitating embodiments described herein. Some embodiments herein are directed to methods that perform operations discussed herein. Operations include receiving (block 802) a wager for a symbol-based wagering game at a gaming device. Some embodiments include determining (block 804) a must-hit-by value corresponding to a mystery progressive wagering game that is provided on the gaming device. Operations include sending (block 806), to multiple gaming devices, the must-hit-by value corresponding to the mystery progressive wagering game and determining (block 808), based on a difference between a mystery progressive award value and the must-hit-by value, an adjusted probability of ones of multiple symbol combinations triggering an award of the mystery progressive wagering game.

Some embodiments provide that the adjusted probability is determined as a non-linear function of the difference between a mystery progressive award value and the must-hit-by value.

Some embodiments include, responsive to the difference between the mystery progressive award value and the must-hit-by value being zero, that the adjusted probability is 1:1.

In some embodiments, operations include receiving (block 810), from the gaming device, an indication that the mystery progressive prize is being awarded, determining (block 812) an updated must-hit-by value, and causing (block 814) the updated must-hit-by value to be sent to other ones of the multiple gaming devices.

In some embodiments, a portion of the symbol combinations in a paytable that trigger the mystery progressive prize and a difference between the must-hit-by value and the mystery progressive award value includes a negative correlation.

In some embodiments, the must-hit-by value includes an upper limit on an amount of time since a previous one of the mystery progressive wagering games awarded the mystery progressive prize. Some embodiments provide that as the amount of time since the previous one of the mystery progressive wagering games awarded the mystery progressive increases, an amount of multiple symbol combinations that cause the mystery progressive to be awarded increases.

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces) and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory comprising machine-readable instructions that, when executed by the processor circuit, cause the processor circuit to:
receive an indication of a wager for a symbol-based wagering game by a player at a first gaming device, the symbol-based wagering game comprising a gaming device wagering game that comprises a gaming device prize that corresponds to the first gaming device and a mystery progressive wagering game that comprises a mystery progressive prize that comprises an initial amount and an additional amount that is funded through a portion of a second machine wager that is received by a second gaming device that is different from the first gaming device;
determine, using a random number generator, a must-hit-by characteristic of the mystery progressive prize; and
generate a plurality of symbol combinations that are defined in a paytable that comprises gaming device prize data, wherein the must-hit-by characteristic is based on a value of the mystery progressive prize,
wherein, the processor circuit is further caused to, based on the value of the mystery progressive prize and the must-hit-by characteristic, update plurality of symbol combinations eligible to win the mystery progressive prize to increase a probability of winning the mystery progressive award, and
wherein responsive to the wagering device generating winning symbol combination corresponding to an award of the mystery progressive prize, the processor circuit is further caused to electronically transmit a win report to the first gaming device and the second gaming device that includes the mystery progressive wagering game.

2. The system of claim 1, wherein the must-hit-by characteristic comprises an upper limit on an amount of time since a previous one of the mystery progressive wagering games awarded the mystery progressive prize.

3. The system of claim 1, wherein the must-hit-by characteristic comprises an upper limit of the value of the mystery progressive prize.

4. The system of claim 3, wherein as the value of the mystery progressive award increases toward the upper limit, additional ones of the plurality of symbol combinations that cause the mystery progressive prize to be awarded are determined.

5. The system of claim 3, wherein responsive to the value of the mystery progressive prize reaching the upper limit, the probability of winning the mystery progressive prize is 1:1.

6. The system of claim 1, wherein the must-hit-by characteristic comprises an upper limit on an amount of time since a previous one of the mystery progressive wagering games awarded the mystery progressive prize.

7. The system of claim 6, wherein as the amount of time since the previous one of the mystery progressive wagering games awarded the mystery progressive prize increases, an amount of the plurality of symbol combinations that cause the mystery progressive prize to be awarded increases.

8. The system of claim 1, wherein responsive to the wagering device generating a winning symbol combination corresponding to an award on the gaming device wagering game and the mystery progressive prize, the processor circuit is further configured to award the gaming device prize.

9. The system of claim 1, wherein responsive to the wagering device generating a winning symbol combination corresponding to an award on the gaming device wagering game and the mystery progressive prize, the processor circuit is further configured to award both of the gaming device prize and the mystery progressive prize.

10. The system of claim 1, wherein the processor circuit is further caused to send a reset signal to the other gaming devices that include the mystery progressive wagering game to cause the mystery progressive prize to be reset to the initial amount.

11. The system of claim 1, wherein the processor circuit is further caused to determine an updated must-hit-by characteristic and to send the updated must-hit-by characteristic to the other gaming devices that include the mystery progressive wagering game.

12. The system of claim 1, wherein the processor circuit comprises a local EGM mystery controller to determine a must-hit-by characteristic that comprises data corresponding to triggering the award of the mystery progressive prize.

13. The system of claim 1, wherein the processor circuit is further caused to determine which one of a plurality of gaming devices that comprise the mystery progressive wagering game will determine the must-hit-by characteristic.

14. A method comprising:
receiving a wager for a symbol-based wagering game at a gaming device;
determining a must-hit-by value corresponding to a mystery progressive wagering game that is provided on the gaming device;
sending, to a plurality of gaming devices that comprises the gaming device, the must-hit-by value corresponding to the mystery progressive wagering game; and
determining, based on a difference between a mystery progressive award value and the must-hit-by value, an adjusted probability of ones of a plurality of symbol combinations triggering an award of the mystery progressive wagering game,
wherein the must-hit-by value comprises an upper limit of the value corresponding to the mystery progressive award value,
wherein as the value of the mystery progressive award increases toward the upper limit, additional ones of the plurality of symbol combinations that cause the mystery progressive award are determined, and
wherein the method further comprises:
determining an updated must-hit-by value; and
causing the updated must-hit-by value to be sent to other ones of the plurality of gaming devices.

15. The method of claim 14, wherein the adjusted probability is determined as a non-linear function of the difference between a mystery progressive award value and the must-hit-by value.

16. The method of claim 15, wherein responsive to the difference between the mystery progressive award value and the must-hit-by value being zero, the adjusted probability is 1:1.

17. The method of claim 15, further comprising:
receiving, from the gaming device, an indication that the mystery progressive prize is being awarded.

18. The method of claim 14, wherein a portion of the symbol combinations in a paytable that trigger the mystery progressive prize and a difference between the must-hit-by value and the mystery progressive award value comprise a negative correlation.

19. The method of claim 14, wherein the must-hit-by value comprises an upper limit on an amount of time since a previous one of the mystery progressive wagering games awarded the mystery progressive prize, and wherein as the amount of time since the previous one of the mystery progressive wagering games awarded the mystery progressive increases, an amount of a plurality of symbol combinations that cause the mystery progressive to be awarded increases.

20. A gaming device comprising:
a display device;
an input device;
a processor circuit; and
a memory comprising machine-readable instructions that, when executed by the processor circuit, cause the processor circuit to:
receive a wager for a symbol-based wagering game at a gaming device;
determine a must-hit-by value corresponding to a mystery progressive wagering game that is provided on the gaming device;
send, to a plurality of gaming devices that comprises the gaming device, the must-hit-by value corresponding to the mystery progressive wagering game;
determine, based on a difference between a mystery progressive award value and the must-hit-by value, an adjusted probability of ones of a plurality of symbol combinations triggering an award of the mystery progressive wagering game;
receive, from the gaming device, an indication that the mystery progressive prize is being awarded;
determine an updated must-hit-by value; and
cause the updated must-hit-by value to be sent to other ones of the plurality of gaming machines,
wherein a portion of the symbol combinations in a paytable that trigger the mystery progressive prize and a difference between the must-hit-by value and the mystery progressive award value comprise a negative correlation,
wherein responsive to the wagering device generating winning symbol combination corresponding to an award of the mystery progressive prize, the processor circuit is further caused to electronically transmit a win report to the first gaming device and the second gaming device that includes the mystery progressive wagering game.
